(19) United States
(12) Patent Application Publication
(10) Pub. No.: US 2026/0095703 A1
(43) Pub. Date: Apr. 2, 2026

(54) MULTIFUNCTIONAL SOUNDING DEVICE AND ELECTRONIC DEVICE

(71) Applicant: MERRY ELECTRONICS (SUZHOU) CO., LTD., Suzhou City (CN)

(72) Inventors: Chunlong ZHENG, Suzhou City (CN); Mingya LUO, Suzhou City (CN); Liguo RAO, Suzhou City (CN)

(73) Assignee: MERRY ELECTRONICS (SUZHOU) CO., LTD., Suzhou City (CN)

(21) Appl. No.: 19/000,449

(22) Filed: Dec. 23, 2024

(30) Foreign Application Priority Data
Sep. 30, 2024 (CN) 202411377369.4

(51) Int. Cl. H04R 9/06

(52) U.S. Cl. CPC H04R 9/06

(57) ABSTRACT

The present disclosure belongs to the technical field of sound-electricity conversions, and provides a multifunctional sounding device and an electronic device. A sounding unit of the multifunctional sounding device includes a vibration assembly fixed to a housing and a magnetic circuit assembly having a magnetic gap, the magnetic circuit assembly is provided with a through hole at a central position, and the vibration assembly vibrates and produces sound in a first direction under a driving of the magnetic circuit assembly. A bearing member is movably connected to the housing through an elastic arm. The motor assembly includes a coil unit accommodated in the through hole and a motor magnet, the coil unit is connected to the bearing member, the motor magnet is connected to the magnetic circuit assembly, and the coil unit is capable of driving the bearing member to vibrate in a second direction.

### CROSS-REFERENCE TO RELATED APPLICATION

This application claims priority to Chinese Patent Application No. 202411377369.4 filed Sep. 30, 2024, the disclosure of which is incorporated herein by reference in its entirety.

### TECHNICAL FIELD

The present disclosure relates to the technical field of sound-electricity conversions, and in particularly, to a multifunctional sounding device and an electronic device.

### BACKGROUND

In the related art, a loudspeaker/receiver and a linear vibration motor applied to a smart watch, a smart phone and a smart wearable device are independently designed and fabricated into functionally unitary parts. The loudspeaker/receiver only serves to convert the electrical signal into the sound signal and transmit the sound signal out, while the linear vibration motor only serves to provide the tactile feedback.

Since the loudspeaker/receiver and the linear vibration motor are independent parts, independent spaces are required when the loudspeaker/receiver and the linear vibration motor are assembled into the smart wearable device. However, the smart wearable device, such as a watch, has a very compact space, so that the space of other parts (such as, a battery) is squeezed, thereby resulting in insufficient cruising and reduced performance. There is an urgent need for a multifunctional sounding device that integrates the loudspeaker/receiver and the linear vibration motor.

### SUMMARY

An objective of the present disclosure is to provide a multifunctional sounding device and an electronic device, to solve the problem that sizes of a loudspeaker/receiver and a linear vibration motor which are independent from each other are relatively large in the related art.

As the conception, the technical solutions adopted by the present disclosure are as follows.

A multifunctional sounding device includes a housing, a sounding unit, a bearing member and a motor assembly. The housing has an accommodation space. The sounding unit is accommodated within the accommodation space and includes a vibration assembly fixed to the housing and a magnetic circuit assembly having a magnetic gap, the magnetic circuit assembly is provided with a through hole at a central position, and the vibration assembly vibrates and produces sound in a first direction under the driving of the magnetic circuit assembly. The bearing member is accommodated within the accommodation space and is movably connected to the housing through an elastic arm. The motor assembly is accommodated within the accommodation space and includes a coil unit accommodated in the through hole and a motor magnet, the coil unit is connected to the bearing member, the motor magnet is connected to the magnetic circuit assembly, the coil unit is capable of driving the bearing member to vibrate in a second direction, and the first direction is perpendicular to the second direction.

Optionally, the magnetic circuit assembly includes a magnetic yoke, a main magnet and a side magnet, the magnetic yoke is connected to an inner wall of the housing, and the main magnet and the side magnet are connected to a side of the magnetic yoke.

Optionally, the magnetic yoke is disposed on a side of the vibration assembly in the first direction, the bearing member is disposed on a side of the magnetic yoke facing away from the vibration assembly, and the main magnet and the side magnet are disposed on a side of the magnetic yoke facing towards the vibration assembly; and the magnetic yoke is provided with a connection portion facing towards the vibration assembly and extending in the first direction, and the motor magnet is connected to the connection portion.

Optionally, the magnetic yoke includes a bearing portion, the through hole disposed at the central position, and a step structure formed by sinking downwards along an edge of the bearing portion close to the through hole, the side magnet is connected to the bearing portion, and the main magnet is connected to the step structure.

Optionally, the connection portion is disposed on the step structure, and the motor magnet is connected to a side of the connection portion facing away from the bearing portion.

Optionally, two groups of main magnets are provided, the two groups of main magnets are disposed opposite to each other in the second direction, two groups of motor magnets are provided, the two groups of motor magnets are located between two groups of main magnets among the two groups of main magnets and are disposed opposite to each other in a third direction, two connection portions are provided, two motor magnets among the two groups of motor magnets are disposed on opposite surfaces of the two connection portions in one-to-one correspondence, and any two of the first direction, the second direction and the third direction are perpendicular to each other; and a first space is formed by enclosing the two groups of main magnets and the two groups of motor magnets, and the coil unit is movably located in the first space.

Optionally, multiple side magnets are provided, and the multiple side magnets are disposed on two opposite sides of the two groups of main magnets and two opposite sides of the two groups of motor magnets.

Optionally, the vibration assembly includes a frame connected to the housing, a vibration diaphragm connected to the frame, and a voice coil inserted into the magnetic gap to drive the vibration diaphragm to vibrate and produce sound, the frame is provided with multiple bending portions, and the multiple bending portions are connected to the multiple side magnets in one-to-one correspondence.

Optionally, the magnetic circuit assembly further includes a magnetizer, the magnetizer is disposed on a side of each of the two groups of main magnets facing away from the step structure and is connected to the two groups of main magnets and has a avoidance hole, the two groups of motor magnets have protrusion portions protruding from the two connection portions, and opposite surfaces of the protrusion portions of the two groups of motor magnets are abutted against a hole wall of the avoidance hole.

Optionally, an edge of the bearing portion facing away from the through hole is provided with a flanged edge extending in the first direction, and the flanged edge is connected to the inner wall of the housing.

Optionally, a counterweight member is disposed on the bearing member, the counterweight member includes a central portion and multiple edge portions, the central portion is connected between the coil unit and the bearing member, and the multiple edge portions are connected to the bearing member and include two edge portions disposed opposite to each other in a vibration direction of the bearing member.

Optionally, two elastic arms are provided and disposed on two sides of the bearing member in the second direction, the two elastic arms and the two edge portions disposed opposite to each other in the vibration direction of the bearing member are connected in one-to-one correspondence, the two elastic arms are elastically connected to the housing and are configured to suspend the central portion, the multiple edge portions and the bearing member within the accommodation space.

Optionally, a circumferential side surface of the bearing member is flush with surfaces of the multiple edge portions facing away from the central portion, or a circumferential side surface of the bearing member is located inside surfaces of the multiple edge portions facing away from the central portion.

An electronic device including the multifunctional sounding device described above is provided.

Beneficial effects of the present disclosure are as follows.

The multifunctional sounding device, the sounding unit, the bearing member and the motor assembly provided in the present disclosure are all accommodated in the accommodation space of the housing, the sounding unit includes the vibration assembly and the magnetic circuit assembly, and the magnetic circuit assembly is capable of driving the vibration assembly to vibrate and produce the sound in the first direction, whereby the sounding of the multifunctional sounding device is achieved. The motor assembly includes the coil unit accommodated in the through hole and the motor magnet, the coil unit is connected to the bearing member and is capable of driving the bearing member to vibrate in the second direction, whereby the linear vibration of the multifunctional sounding device is achieved. The multifunctional sounding device integrates functions of the loudspeaker/receiver and the linear vibration motor and has a relatively small volume, so that a space required to be occupied in the electronic device is relatively small, and thus the multifunctional sounding device is capable of being applied to the electronic device with the relatively high requirement for size.

Moreover, the motor magnet of the motor assembly, and the main magnet and the side magnet of the magnetic circuit assembly are connected to the magnetic yoke to be supported through the magnetic yoke, and the magnetic yoke is connected to the housing, so that the motor magnet, the main magnet, the side magnet, the magnetic yoke and the housing may be connected into a whole, thereby improving the whole structural strength, having the relatively high reliability, and reducing the probability of disengagement of the motor magnet, the main magnet and the side magnet.

In addition, when the coil unit drives the bearing member to vibrate, the motor magnet, the main magnet, the side magnet and the magnet yoke do not move, thereby ensuring the stability of sounding, reducing the influence of the motor assembly on the multifunctional sounding device, improving the structural stability of the whole multifunctional sounding device, and ensuring the working stability of the multifunctional sounding device.

### BRIEF DESCRIPTION OF THE DRAWINGS

In order to describe technical solutions in embodiments of the present disclosure more clearly, drawings that are required to be used in the description of the embodiments of the present disclosure are briefly described hereinafter, the drawings in the following description merely depict some embodiments of the present disclosure, and other drawings may also be obtained on the basis of the contents of the embodiments of the present disclosure and these drawings by those of ordinary skill in the art without making creative efforts.

FIG. 1 is a schematic structural view of a multifunctional sounding device according to an embodiment of the present disclosure;

FIG. 2 is an exploded view of a multifunctional sounding device according to an embodiment of the present disclosure;

FIG. 3 is a schematic structural view one of part of a multifunctional sounding device according to an embodiment of the present disclosure;

FIG. 4 is a schematic structural view two of part of a multifunctional sounding device according to an embodiment of the present disclosure;

FIG. 5 is a schematic structural view of a magnetic yoke according to an embodiment of the present disclosure;

FIG. 6 is an exploded view of a vibration assembly according to an embodiment of the present disclosure;

FIG. 7 is a top view of a multifunctional sounding device according to an embodiment of the present disclosure;

FIG. 8 is a section view taken along A-A shown in FIG. 7 according to the present disclosure; and

FIG. 9 is a section view taken along B-B shown in FIG. 7 according to the present disclosure.

### LIST OF REFERENCE NUMBERS

100 housing
110 accommodation space
120 sound outlet hole
130 top cover
140 bottom housing
200 sounding unit
210 vibration assembly
211 vibration diaphragm
212 voice coil
213 frame
2131 bending portion
214 voice cavity
220 magnetic circuit assembly
221 counterweight member
2211 central portion
2212 edge portion
2213 elastic arm
222 main magnet
223 side magnet
224 magnetic gap
230 first space
240 magnetizer
241 avoidance hole
300 magnetic yoke
310 connection portion
320 step structure
321 through hole
330 bearing portion
331 flanged edge
400 bearing member
500 motor assembly
510 coil unit
520 motor magnet
X first direction
Y second direction
Z third direction

### DETAILED DESCRIPTION

In order to make solved technical problems, adopted technical solutions and achieved technical effects of the present disclosure more apparent, the technical solutions of the present disclosure are further described below in conjunction with drawings and specific embodiments. It is to be understood that the specific embodiments described herein are merely used for explaining the present disclosure and are not intended to limit the present disclosure. It is also to be noted that, for ease of description, only some, but not all, of the structures related to the present disclosure are shown in the drawings.

It is to be noted that like reference numbers and letters represent like items in the following drawings, and thus, once a certain item is defined in one drawing, this item need not be further defined and explained in subsequent drawings.

In the description of the present disclosure, unless otherwise expressly specified and limited, the term “connected to each other”, “connected”, or “fixed” is to be construed in a broad sense. For example, the term “connected” may refer to “fixedly connected” or “detachably connected” or “integrally connected”, may refer to “mechanically connected” or “electrically connected”, or may refer to “connected directly”, “connected indirectly through an intermediary” or “internal connection between two elements, or interaction between two elements”. For those of ordinary skill in the art, specific meanings of the preceding terms in the present disclosure may be understood based on specific situations.

In the present disclosure, unless otherwise expressly specified and limited, a first feature being “on” or “under” a second feature may include the first feature and the second feature being in direct contact, or may include the first feature and the second feature not being in direct contact but being in contact with each other through an additional feature therebetween. Moreover, the first feature being “on”, “above” or “over” the second feature includes the first feature being directly on, above or over and obliquely on, above or over the second feature, or simply represents that the first feature is at a higher level than the second feature. The first feature being “under”, “below” or “underneath” the second feature includes the first feature being directly under, below or underneath and obliquely under, below or underneath the second feature, or simply represents that the first feature is at a lower level than the second feature. In the description of this embodiment, unless specified otherwise, “multiple” specifically refers to two or more.

In the description of this embodiment, the orientational or positional relationships indicated by terms “above”, “below”, “right”, and the like are based on the orientational or positional relationships shown in the drawings, and are merely for ease of description and simplifying an operation, rather than indicating or implying that the referred device or element must have a specific orientation and be constructed and operated in a specific orientation, and thus they are not to be construed as limiting the present disclosure. Moreover, the terms “first” and “second” are used only to distinguish between descriptions and have no special meaning.

It is to be noted that when an element is referred to as being “fixed to” or “disposed on” another element, this element may be directly on the another element, or a central element may also exist.

The technical solutions of the present disclosure will be further described below in conjunction with the drawings and the specific embodiments.

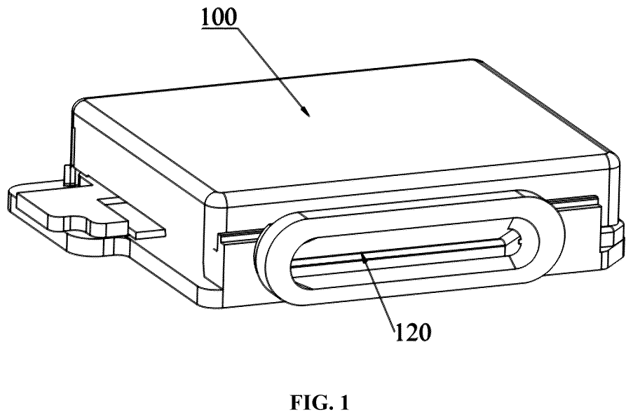

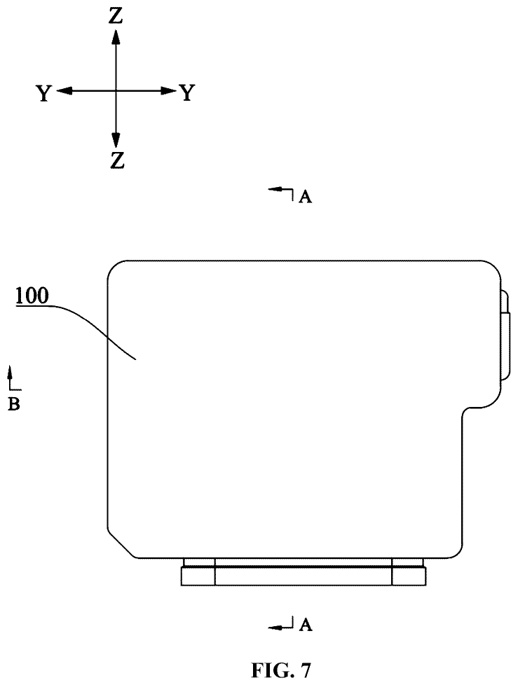

As shown in FIG. 1 to FIG. 9, this embodiment provides a multifunctional sounding device. The multifunctional sounding device is capable of simultaneously having functions of a loudspeaker/receiver and a linear vibration motor, has a relatively small overall size compared with the multifunctional sounding device in which a loudspeaker/receiver and a linear vibration motor are disposed separately, and is capable of being applied to an electronic device with a relatively high requirement for size.

Before this embodiment is introduced, directions involved in this embodiment are described. In this embodiment, a first direction X, a second direction Y, and a third direction Z are defined, where any two of the first direction X, the second direction Y, and the third direction Z are perpendicular to each other. Exemplarily, the multifunctional sounding device of a cuboid shape is used as an example, the first direction X may be a height direction of the multifunctional sounding device, one of the second direction Y and the third direction Z is a length direction of the multifunctional sounding device, and the other of the second direction Y and the third direction Z is a width direction of the multifunctional sounding device. A length and a width of the multifunctional sounding device may be the same or different, which is not limited in this embodiment. The length and the width of the multifunctional sounding device are greater than a height of the multifunctional sounding device.

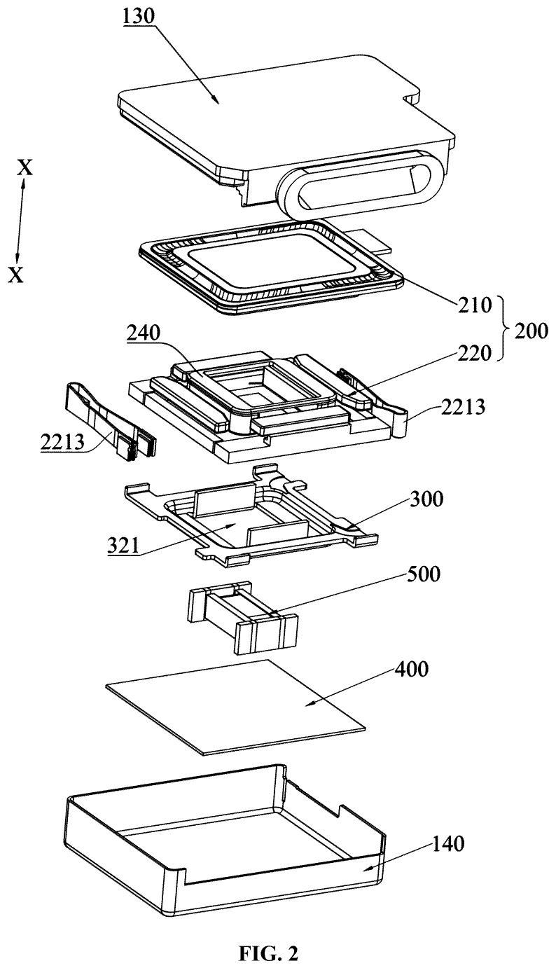

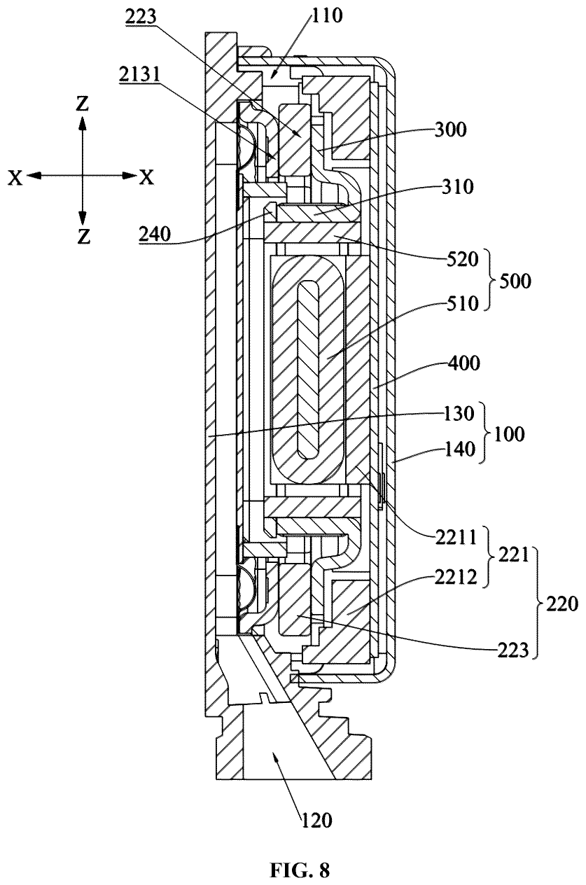

As shown in FIG. 1, the multifunctional sounding device includes a housing 100. As shown in FIG. 8, the housing 100 has an accommodation space 110. In some embodiments, as shown in FIG. 2, the housing 100 may include a bottom housing 140 and a top cover 130 connected to each other, and the bottom housing 140 is fitted with the top cover 130 to form the accommodation space 110. As shown in FIG. 8, the housing 100 may also be provided with a sound outlet hole 120, and the sound outlet hole 120 communicates with the accommodation space 110 and is configured to transmit out the sound of the multifunctional sounding device. For example, the sound outlet hole 120 may be disposed on the top cover 130.

As shown in FIG. 2, the multifunctional sounding device further includes a sounding unit 200, a bearing member 400 and a motor assembly 500 which are all accommodated within the accommodation space 110. The sounding unit 200 is accommodated within the accommodation space 110 and includes a vibration assembly 210 fixed to the housing 100 and a magnetic circuit assembly 220 having a magnetic gap 224. The magnetic circuit assembly 220 is provided with a through hole 321 at a central position, and the vibration assembly 210 vibrates and produces sound in the first direction X under the driving of the magnetic circuit assembly 220, thereby enabling the multifunctional sounding device to have the sounding function.

The bearing member 400 is accommodated within the accommodation space 110 and is movably connected to the housing 100 through an elastic arm 2213, so that the bearing member 400 is capable of moving and resetting in the accommodation space 110.

In this embodiment, the motor assembly 500 is accommodated within the accommodation space 110 and includes a coil unit 510 accommodated in the through hole 321 and a motor magnet 520. The coil unit 510 is connected to the bearing member 400, and the motor magnet 520 is connected to the magnetic circuit assembly 220. It is to be noted that the coil unit 510 is capable of driving the bearing member 400 to vibrate in the second direction Y, thereby enabling the multifunctional sounding device to have the linear vibration function.

Exemplarily, the coil unit 510 may include a motor winding coil and an iron core with an I-shaped cross section, where the motor winding coil is wound around the iron core. After the motor winding coil is energized, under the action of the magnetic field of the motor magnet 520, the coil unit 510 reciprocates in a direction (such as, the second direction Y) perpendicular to the first direction X, and further drives the bearing member 400 to reciprocate in the direction perpendicular to the first direction X, to achieve the linear vibration.

The multifunctional sounding device, the sounding unit 200, the bearing member 400 and the motor assembly 500 provided in this embodiment are all accommodated in the accommodation space 110 of the housing 100, the sounding unit 200 includes the vibration assembly 210 and the magnetic circuit assembly 220, and the magnetic circuit assembly 220 is capable of driving the vibration assembly 210 to vibrate and produce the sound in the first direction X, whereby the sounding of the multifunctional sounding device is achieved. The motor assembly 500 includes the coil unit 510 accommodated in the through hole 321 and the motor magnet 520, the coil unit 510 is connected to the bearing member 400 and is capable of driving the bearing member 400 to vibrate in the second direction Y, whereby the linear vibration of the multifunctional sounding device is achieved. The multifunctional sounding device integrates functions of the loudspeaker/receiver and the linear vibration motor and has a relatively small volume, so that a space required to be occupied in the electronic device is relatively small, and thus the multifunctional sounding device is capable of being applied to the electronic device with the relatively high requirement for size.

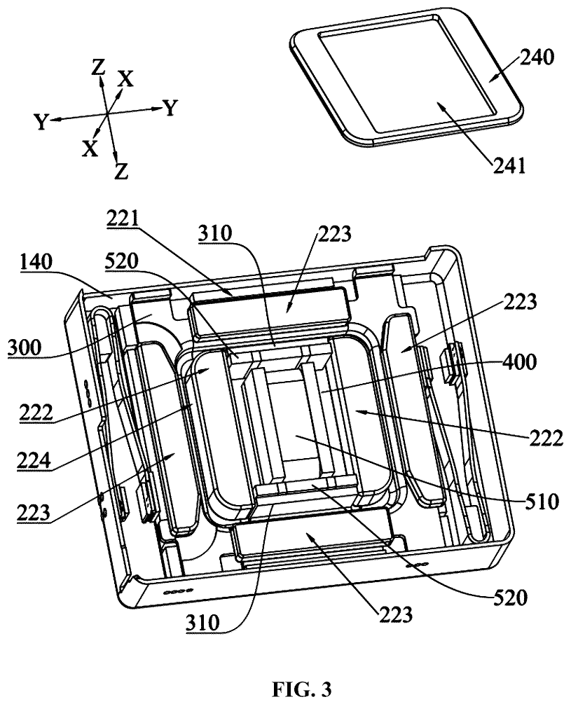

Optionally, as shown in FIG. 3, the magnetic circuit assembly 220 in this embodiment includes a magnetic yoke 300, a main magnet 222 and a side magnet 223. The magnetic yoke 300 is connected to an inner wall of the housing 100. The side magnet 223 and the main magnet 222 are connected to a side of the magnetic yoke 300. The side magnet 223 and the main magnet 222 are disposed at intervals to form the magnetic gap 224. In this embodiment, the magnetic yoke 300 is connected to the inner wall of the housing 100 to be supported through the housing 100, and the main magnet 222 and the side magnet 223 are connected to the side of the magnetic yoke 300, so that the main magnet 222 and the side magnet 223 may be indirectly supported on the housing 100 by means of the magnetic yoke 300.

Optionally, the bearing member 400 is made of a hard material, such as metal and plastic. Preferably, the bearing member 400 is made of steel.

In this embodiment, the motor magnet 520 of the motor assembly 500, and the main magnet 222 and the side magnet 223 of the magnetic circuit assembly 220 are connected to the magnetic yoke 300 to be supported through the magnetic yoke 300, and the magnetic yoke 300 is connected to the housing 100, so that the motor magnet 520, the main magnet 222, the side magnet 223, the magnetic yoke 300 and the housing 100 may be connected into a whole, thereby improving the whole structural strength, having the relatively high reliability, and reducing the probability of disengagement of the motor magnet 520, the main magnet 222 and the side magnet 223.

In addition, when the coil unit 510 drives the bearing member 400 to vibrate, the motor magnet 520, the main magnet 222, the side magnet 223 and the magnet yoke 300 do not move, thereby ensuring the stability of sounding, reducing the influence of the motor assembly 500 on the multifunctional sounding device, improving the structural stability of the whole multifunctional sounding device, and ensuring the working stability of the multifunctional sounding device.

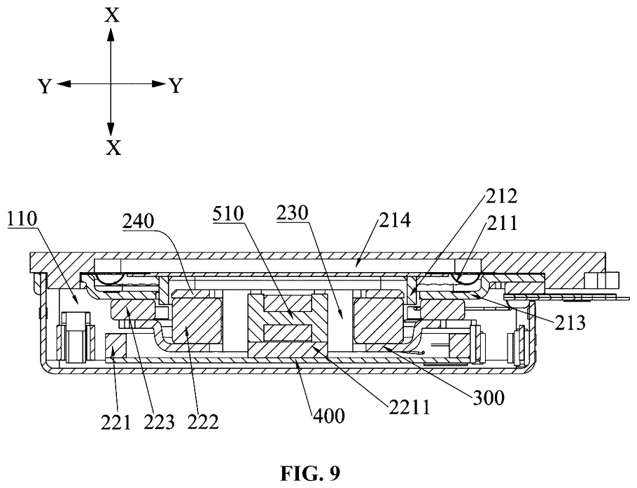

Exemplarily, in conjunction with FIGS. 2 and 9, the magnetic yoke 300 is disposed on a side of the vibration assembly 210 in the first direction X, the bearing member 400 is disposed on a side of the magnetic yoke 300 facing away from the vibration assembly 210, and the main magnet 222 and the side magnet 223 are disposed on a side of the magnetic yoke 300 facing towards the vibration assembly 210.

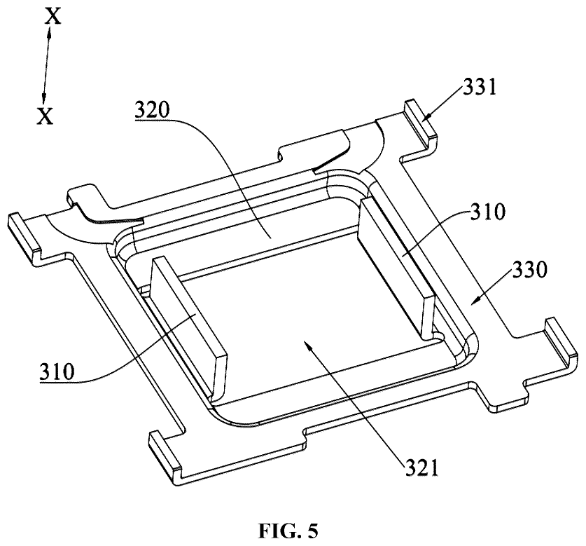

In some optional embodiments, as shown in FIG. 5, the magnetic yoke 300 is provided with a connection portion 310 extending in the first direction X. Specifically, the connection portion 310 is disposed on the side of the magnetic yoke 300 facing towards the vibration assembly 210. The motor magnet 520 is connected to the connection portion 310, that is, the motor magnet 520 is located on the side of the magnetic yoke 300 facing towards the vibration assembly 210. The connection portion 310 is provided so that the motor magnet 520 is fixed, and the space inside the housing 100 may also be adjusted, thereby improving the space utilization rate. Exemplarily, a large surface of the motor magnet 520 is connected to the connection portion 310, so that the connection strength between the large surface of the motor magnet 520 and the connection portion 310 is increased, the risk that the motor magnet 520 drops when the multifunctional sounding device vibrates violently is reduced, and thus the relatively high reliability is obtained. Optionally, the motor magnet 520 may be adhered to the connection portion 310, or may be connected to the connection portion 310 in other connection manners.

In some embodiments, the magnetic yoke 300 may be plate-shaped, and the magnetic yoke 300 extends in a plane in which the second direction Y and the third direction Z are located.

Further optionally, with continued reference to FIG. 5, the magnetic yoke 300 includes a bearing portion 330, the above-described through hole 321 disposed at the central position of the bearing portion 330, and a step structure 320 formed by sinking downwards along an edge of the bearing portion 330 close to the through hole 321, that is, part of the surface of the bearing portion 330 is sank to form the step structure 320. The side magnet 223 is connected to the bearing portion 330, and the main magnet 222 is connected to the step structure 320. The main magnet 222 is connected to the step structure 320 formed by sinking, so that a size of the main magnet 222 in the first direction X may be relatively large without increasing a size of the multifunctional sounding device in the first direction X, whereby components within the multifunctional sounding device may be more compact. In some optional embodiments, the through hole 321 is used for the coil unit 510 to pass through and is connected to the bearing member 400.

In some embodiments, with continued reference to FIG. 5, the connection portion 310 is disposed on the step structure 320, and the motor magnet 520 is connected to a side of the connection portion 310 facing away from the bearing portion 330, that is, the motor magnet 520 is disposed on a side of the connection portion 310 facing towards the through hole 321. The connection portion 310 is disposed on the step structure 320, so that the space formed by enclosing the main magnet 222 and the side magnet 223 can be sufficiently utilized, and the compactness of the multifunctional sounding device in the first direction X can be further improved, thereby facilitating the miniaturization of the multifunctional sounding device. Furthermore, the motor magnet 520 may be close to the bearing member 400 as far as possible, so that a distance between the coil unit 510 and the bearing member 400 may be relatively small, thereby facilitating the connection between the coil unit 510 and the bearing member 400.

Optionally, an edge of the bearing portion 330 facing away from the through hole 321 is provided with a flanged edge 331 extending in the first direction X, and the flanged edge 331 is connected to the inner wall of the housing 100, so that the flanged edge 331 has a relatively large contact area with the inner wall of the housing 100 and thus has a relatively high connection strength. Exemplarily, multiple flanged edges 331 may be provided, and the multiple flanged edges 331 are disposed at intervals. The flanged edges 331 are disposed at intervals, so that compared with the flanged edges 331 being disposed in a circumferential ring-shaped structure, the weight of the magnetic yoke 300 may be relatively small, and further the overall weight of the multifunctional sounding device is reduced.

In some embodiments, the magnetic yoke 300 may also be provided with a hollow hole, or an opening is formed at an edge of the magnetic yoke 300, to reduce the own weight of the magnetic yoke 300, thereby enabling the multifunctional sounding device to be relatively light, and improving the lightweight of the multifunctional sounding device.

In some optional embodiments, the magnetic yoke 300 is of an integrated structure, that is, the bearing portion 330, the step structure 320, the connection portion 310 and the flanged edge 331 may each be manufactured from one plate, to have the relatively high structural strength. Of course, it is to be understood that the magnetic yoke 300 may also be of a split structure, which is not limited in this embodiment.

Optionally, two groups of main magnets 222 are provided in this embodiment, and as shown in FIG. 3, the two groups of main magnets 222 are disposed opposite to each other in the second direction Y. Two groups of motor magnets 520 are provided, the two groups of motor magnets 520 are located between two groups of main magnets 222 and are disposed opposite to each other in the third direction Z, and the coil unit 510 is capable of driving the bearing member 400 to vibrate in the second direction Y. Two connection portions 310 are provided, and two motor magnets 520 are disposed on opposite surfaces of the two connection portions 310 in one-to-one correspondence, to fix the two motor magnets 520.

The two motor magnets 520 are disposed between the two groups of main magnets 222, so that a maximum distance of the two groups of motor magnets 520 in the third direction Z is not greater than a size of the two groups of main magnets 222 in the third direction Z, and thus the two groups of main magnets 222 and the two groups of motor magnets 520 can make full use of the space in the third direction Z, thereby further facilitating the miniaturization of the multifunctional sounding device.

In some optional embodiments, the two connection portions 310 are also located between the two groups of main magnets 222, for example, two ends of the main magnet 222 in the third direction Z are flush with opposite surfaces of the two connection portions 310, on one hand, the length of the main magnet 222 may be relatively small, and on the other hand, the overall size of the main magnet 222, the connection portion 310 and the motor magnet 520 may be relatively small, so that the size of the step structure 320 may be relatively small, thereby further facilitating the miniaturization and the lightweight of the multifunctional sounding device.

Optionally, as shown in FIG. 9, a first space 230 is formed by enclosing the two groups of main magnets 222 and the two groups of motor magnets 520, and the coil unit 510 is movably located in the first space 230, so that the coil unit 510 may be disposed opposite to the motor magnet 520. The coil unit 510 is disposed in the first space 230, so that the magnetic circuit assembly 220 may be clearance-fitted with the motor assembly 500, the overall structure of the magnetic circuit assembly 220 and the motor assembly 500 is more compact, and thus the lightweight of the multifunctional sounding device in the first direction X can be achieved. In this embodiment, the first space 230 communicates with the through hole 321.

In some optional embodiments, as shown in FIG. 3, multiple side magnets 223 are provided. The multiple side magnets 223 are disposed on two opposite sides of the two groups of main magnets 222 and two opposite sides of the two groups of motor magnets 520, and a magnetic gap 224 is formed between the main magnet 222 and the side magnet 223. In some embodiments, the magnetic gap 224 may also be formed between the motor magnet 520 and the side magnet 223. In this way, the magnetic field intensity can be enhanced, and the sound effect of the vibration assembly 210 can also be enhanced.

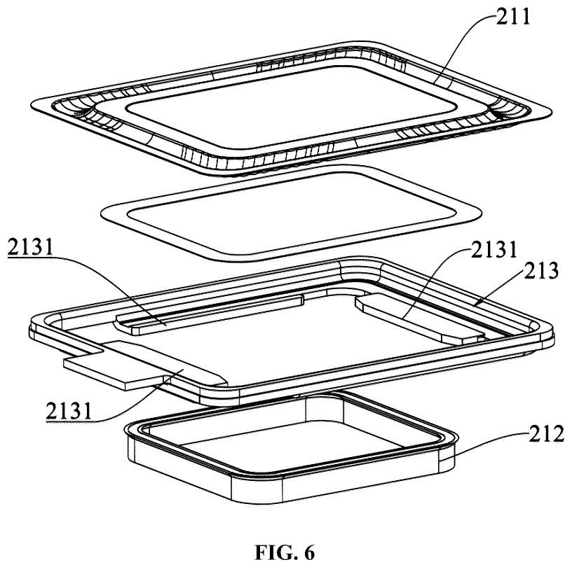

In some optional embodiments, as shown in FIG. 6, the vibration assembly 210 includes a frame 213 connected to the housing 100, a vibration diaphragm 211 connected to the frame 213, and a voice coil 212 inserted into the magnetic gap 224 to drive the vibration diaphragm 211 to vibrate and produce sound. As shown in FIG. 9, a voice cavity 214 is formed between the vibration diaphragm 211 and the top cover 130, and the voice cavity 214 communicates with the sound outlet hole 120. The frame 213 is provided with multiple bending portions 2131, and the multiple bending portions 2131 are connected to the multiple side magnets 223 in one-to-one correspondence, to further improve the integrity of the vibration assembly 210 and the side magnet 223, and ensure the vibration sounding performance of the vibration assembly 210.

Optionally, the bending portion 2131 extends in the second direction Y or the third direction Z, and a large surface of the bending portion 2131 is in contact with the side magnet 223 to have a relatively large connection area with the side magnet 223, thereby improving the connection strength. In this embodiment, the bending portion 2131 is sank relative to the frame 213 and is in contact with the side magnet 223, to prevent the positional interference of the frame 213 and the side magnet 223. In this embodiment, four side magnets 223 and four bending portions 2131 are provided.

In some optional embodiments, a surface of the side magnet 223 facing away from the magnetic yoke 300 is flush with a surface of the main magnet 222 facing away from the step structure 320, so that the side magnet 223 and the main magnet 222 do not additionally occupy a relatively large size in the first direction X on the basis of ensuring formation of the magnetic gap 224, which facilitates reduction of the size of the multifunctional sounding device in the first direction X. Similarly, a surface of the coil unit 510 facing towards the vibration assembly 210 is flush with a surface of the motor magnet 520 facing towards the vibration assembly 210, so that the coil unit 510 and the motor magnet 520 do not occupy too much space in the first direction X on the basis of ensuring the vibration function, thereby facilitating the reduction of the size of the multifunctional sounding device in the first direction X.

In some optional embodiments, as shown in FIG. 2 and FIG. 3, the magnetic circuit assembly 220 further includes a magnetizer 240. The magnetizer 240 is disposed on a side of the main magnet 222 facing away from the step structure 320, that is, the magnetizer 240 is disposed on a top surface of the main magnet 222 and is connected to the two groups of main magnets 222. The magnetizer 240 may be used for magnetic conduction.

Further optionally, the magnetizer 240 has an avoidance hole 241, that is, the magnetizer 240 is ring-shaped. Moreover, the magnetizer 240 is also connected to the two connection portions 310. The motor magnet 520 has a protrusion portion (not shown) protruding from the connection portion 310, that is, part of the motor magnet 520 is connected to the connection portion 310, and remaining part of motor magnet 520 is not connected to the connection portion 310. Opposite surfaces of the protrusion portions of the two groups of motor magnets 520 are abutted against a hole wall of the avoidance hole 241, so that the magnetizer 240 may also be used to limit the motor magnet 520, thereby further improving the stability of the motor magnet 520. The avoidance hole 241 in this embodiment is configured to avoid the magnetic gap 224, so that the voice coil 212 of the vibration assembly 210 may be smoothly inserted into the magnetic gap 224.

It is to be noted that a surface of the magnetizer 240 facing away from the main magnet 222 is flush with a top surface of the motor magnet 520, that is, a height of the protrusion portion is equal to a thickness of the magnetizer 240, so that the magnetic circuit assembly 220 has a relatively neat appearance, and thus unevenness is avoided.

Optionally, as shown in FIG. 3, the multifunctional sounding device further includes a counterweight member 221, and the counterweight member 221 is disposed on the bearing member 400, so that the counterweight member 221 may be driven to move when the bearing member 400 moves.

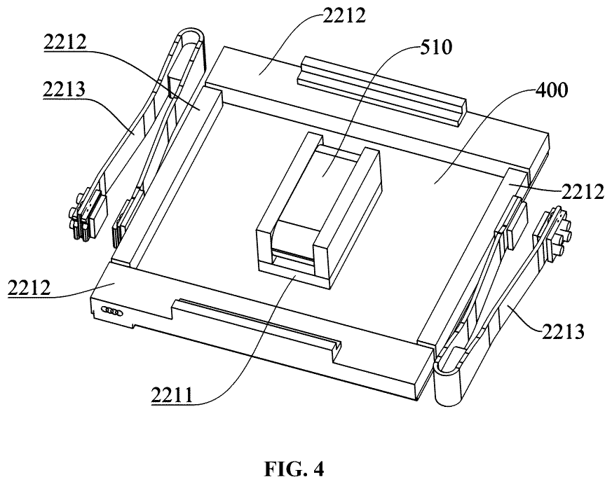

Further optionally, as shown in FIG. 4, the counterweight member 221 includes a central portion 2211 and multiple edge portions 2212. The central portion 2211 is connected between the coil unit 510 and the bearing member 400, that is, the coil unit 510 is connected to the bearing member 400 through the central portion 2211. Of course, it is to be understood that the coil unit 510 may also be directly connected to the bearing member 400, or the coil unit 510 is connected to the bearing member 400 through other components, which is not limited in this embodiment.

When the coil unit 510 is connected to the bearing member 400 through the central portion 2211, since the coil unit 510 is located on a side of the magnetic yoke 300 facing away from the bearing member 400, the central portion 2211 passes through the step structure 320 and is connected to the coil unit 510. In this embodiment, a gap exists between the magnetic yoke 300 and the bearing member 400, so that the magnetic yoke 300 does not interfere with the movement of the bearing member 400.

In this embodiment, the multiple edge portions 2212 are all connected to the bearing member 400, for example, the multiple edge portions 2212 are all disposed on a side of the bearing member 400 facing towards the magnetic yoke 300. In some optional embodiments, the multiple edge portions 2212 are disposed at intervals in a circumferential direction of the bearing member 400. The multiple edge portions 2212 include two edge portions 2212 disposed opposite to each other in a vibration direction of the bearing member 400.

Optionally, two elastic arms 2213 may be provided and are disposed on two sides of the bearing member 400 in the second direction Y. The two elastic arms 2213 and the two edge portions 2212 disposed opposite to each other in the vibration direction of the bearing member 400 are connected in one-to-one correspondence, and the elastic arms 2213 are elastically connected to the housing 100 and are configured to suspend the central portion 2211, the multiple edge portions 2212 and the bearing member 400 within the accommodation space 110 for resetting the central portion 2211, the multiple edge portions 2212 and the bearing member 400.

For example, four edge portions 2212 are provided, the bearing member 400 has a square plate-shaped structure, and the four edge portions 2212 are disposed at four edge positions of the bearing member 400. Two edge portions among the four edge portions 2212 and the two elastic arms 2213 connected to in one-to-one correspondence, and the other two edge portions 2212 among the four edge portions 2212 have protrusion structures (not shown in the drawings) protruding towards the side magnets 223.

In some optional embodiments, a circumferential side surface of the bearing member 400 is flush with each surface of surfaces of the edge portions 2212 facing away from the central portion 2211, or a circumferential side surface of the bearing member 400 is located inside each surface of surfaces of the edge portions 2212 facing away from the central portion 2211, so that a size of the bearing member 400 does not additionally increase a size of the housing 100, thereby facilitating the miniaturization of the multifunctional sounding device.

This embodiment further provides an electronic device including the multifunctional sounding device described above. The electronic device does not need to reserve a large installation space for the multifunctional sounding device, so that sizes of batteries or other components within the electronic device may be relatively large in a case of the same size, and further the cruising ability or other performances of the electronic device can be improved.

The electronic device may include a device having a speaker, such as a mobile phone, a tablet personal computer, a laptop, a personal digital assistant (PDA), a camera, a personal computer, a notebook, a vehicle-mounted device, a smart wearable device, augmented reality (AR) glasses, an AR helmet, virtual reality (VR) glasses, a VR helmet, a fixed-line handset (microphone), a medical auxiliary device (such as, a hearing aid), and various headphones (such as, a wireless headphone or a wired headphone). The specific form of the above-described electronic device is not particularly limited in the embodiments of the present application.

It is to be noted that the above contents are merely preferred embodiments of the present disclosure and the technical principles applied herein. It is to be understood by those skilled in the art that the present disclosure is not limited to the particular embodiments described herein. For those skilled in the art, various apparent variations, rearrangements and substitutions may be made without departing from the scope of protection of the present disclosure. Therefore, although the present disclosure has been described in detail through the above embodiments, the present disclosure is not limited to the above embodiments and may include more other equivalent embodiments without departing from the concept of the present disclosure. The scope of the present disclosure is determined by the scope of the appended claims.

What is claimed is:

1. A multifunctional sounding device, comprising:
a housing having an accommodation space;
a sounding unit accommodated within the accommodation space, wherein the sounding unit comprises a vibration assembly fixed to the housing and a magnetic circuit assembly having a magnetic gap, the magnetic circuit assembly is provided with a through hole at a central position, and the vibration assembly vibrates and produces sound in a first direction under driving of the magnetic circuit assembly;
a bearing member accommodated within the accommodation space and movably connected to the housing through an elastic arm; and
a motor assembly accommodated within the accommodation space, wherein the motor assembly comprises a coil unit accommodated in the through hole and a motor magnet, the coil unit is connected to the bearing member, the motor magnet is connected to the magnetic circuit assembly, the coil unit is capable of driving the bearing member to vibrate in a second direction, and the first direction is perpendicular to the second direction.

2. The multifunctional sounding device of claim 1, wherein the magnetic circuit assembly comprises a magnetic yoke, a main magnet and a side magnet, the magnetic yoke is connected to an inner wall of the housing, and the main magnet and the side magnet are connected to a side of the magnetic yoke.

3. The multifunctional sounding device of claim 2, wherein the magnetic yoke is disposed on a side of the vibration assembly in the first direction, the bearing member is disposed on a side of the magnetic yoke facing away from the vibration assembly, and the main magnet and the side magnet are disposed on a side of the magnetic yoke facing towards the vibration assembly; and
the magnetic yoke is provided with a connection portion facing towards the vibration assembly and extending in the first direction, and the motor magnet is connected to the connection portion.

4. The multifunctional sounding device of claim 3, wherein the magnetic yoke comprises a bearing portion, the through hole disposed at a central position of magnetic yoke, and a step structure formed by sinking downwards along an edge of the bearing portion close to the through hole, the side magnet is connected to the bearing portion, and the main magnet is connected to the step structure.

5. The multifunctional sounding device of claim 4, wherein the connection portion is disposed on the step structure, and the motor magnet is connected to a side of the connection portion facing away from the bearing portion.

6. The multifunctional sounding device of claim 5, wherein two groups of main magnets are provided, the two groups of main magnets are disposed opposite to each other in the second direction, two groups of motor magnets are provided, the two groups of motor magnets are located between two groups of main magnets and are disposed opposite to each other in a third direction, two connection portions are provided, two motor magnets are disposed on opposite surfaces of the two connection portions in one-to-one correspondence, and any two of the first direction, the second direction and the third direction are perpendicular to each other; and
a first space is formed by enclosing the two groups of main magnets and the two groups of motor magnets, and the coil unit is movably located in the first space.

7. The multifunctional sounding device of claim 6, wherein a plurality of side magnets are provided, and the plurality of side magnets are disposed on two opposite sides of the two groups of main magnets and two opposite sides of the two groups of motor magnets.

8. The multifunctional sounding device of claim 7, wherein the vibration assembly comprises a frame connected to the housing, a vibration diaphragm connected to the frame, and a voice coil inserted into the magnetic gap to drive the vibration diaphragm to vibrate and produce sound, the frame is provided with a plurality of bending portions, and the plurality of bending portions are connected to the plurality of side magnets in one-to-one correspondence.

9. The multifunctional sounding device of claim 6, wherein the magnetic circuit assembly further comprises a magnetizer, the magnetizer is disposed on a side of each of the two groups of main magnets facing away from the step structure and is connected to the two groups of main magnets, the magnetizer has a avoidance hole, a motor magnet of the two groups of motor magnets has a protrusion portion protruding from a connection portion of the two connection portions, and opposite surfaces of the protrusion portions of the two groups of motor magnets are abutted against a hole wall of the avoidance hole.

10. The multifunctional sounding device of claim 4, wherein an edge of the bearing portion facing away from the through hole is provided with a flanged edge extending in the first direction, and the flanged edge is connected to the inner wall of the housing.

11. The multifunctional sounding device of claim 1, wherein a counterweight member is disposed on the bearing member, the counterweight member comprises a central portion and a plurality of edge portions, the central portion is connected between the coil unit and the bearing member, and the plurality of edge portions are connected to the bearing member and comprise two edge portions disposed opposite to each other in a vibration direction of the bearing member.

12. The multifunctional sounding device of claim 11, wherein two elastic arms are provided and the two elastic arms are disposed on two sides of the bearing member in the second direction, the two elastic arms and the two edge portions disposed opposite to each other in the vibration direction of the bearing member are connected in one-to-one correspondence, the two elastic arms are elastically connected to the housing and are configured to suspend the central portion, the plurality of edge portions and the bearing member within the accommodation space.

13. The multifunctional sounding device of claim 11, wherein a circumferential side surface of the bearing member is flush with a surface of an edge portion of the plurality of edge portions facing away from the central portion, or a circumferential side surface of the bearing member is located inside a surface of an edge portion of the plurality of edge portions facing away from the central portion.

14. The multifunctional sounding device of claim 5, wherein an edge of the bearing portion facing away from the through hole is provided with a flanged edge extending in the first direction, and the flanged edge is connected to the inner wall of the housing.

15. The multifunctional sounding device of claim 6, wherein an edge of the bearing portion facing away from the through hole is provided with a flanged edge extending in the first direction, and the flanged edge is connected to the inner wall of the housing.

16. The multifunctional sounding device of claim 7, wherein an edge of the bearing portion facing away from the through hole is provided with a flanged edge extending in the first direction, and the flanged edge is connected to the inner wall of the housing.

17. The multifunctional sounding device of claim 8, wherein an edge of the bearing portion facing away from the through hole is provided with a flanged edge extending in the first direction, and the flanged edge is connected to the inner wall of the housing.

18. The multifunctional sounding device of claim 2, wherein a counterweight member is disposed on the bearing member, the counterweight member comprises a central portion and a plurality of edge portions, the central portion is connected between the coil unit and the bearing member, and the plurality of edge portions are connected to the bearing member and comprise two edge portions disposed opposite to each other in a vibration direction of the bearing member.

19. The multifunctional sounding device of claim 3, wherein a counterweight member is disposed on the bearing member, the counterweight member comprises a central portion and a plurality of edge portions, the central portion is connected between the coil unit and the bearing member, and the plurality of edge portions are connected to the bearing member and comprise two edge portions disposed opposite to each other in a vibration direction of the bearing member.

20. An electronic device, comprising the multifunctional sounding device of claim 1.
